(19) United States
(12) Patent Application Publication
(10) Pub. No.: US 2026/0209897 A1
(43) Pub. Date: Jul. 23, 2026

(54) ULTRAHIGH STRAIN RECOVERY SHAPE MEMORY ALLOY SCREEN PIPE MATERIAL AND PREPARATION METHOD AND APPLICATION THEREOF

(71) Applicant: South China University of Technology, Guangzhou, Guangdong (CN)

(72) Inventors: Bin Yuan, Guangzhou, Guangdong (CN); Guining Xiang, Guangzhou, Guangdong (CN); Hao Li, Guangzhou, Guangdong (CN); Chao Yang, Guangzhou, Guangdong (CN); Yan Gao, Guangzhou, Guangdong (CN); Min Zhu, Guangzhou, Guangdong (CN)

(21) Appl. No.: 19/141,054

(22) PCT Filed: Nov. 29, 2022
(86) PCT No.: PCT/CN2022/135116

§ 371 Date: Jun. 19, 2025

(30) Foreign Application Priority Data
Dec. 17, 2021 (CN) 202111554837.7

(51) Int. Cl. C22C 19/03; C22F 1/10; E21B 43/08

(52) U.S. Cl. CPC C22C 19/03; C22F 1/10; E21B 43/082

(57) ABSTRACT

An ultrahigh strain recovery shape memory alloy screen pipe material and a preparation method and application thereof. The material is obtained by cold pressing molding of a preform, the preform is prepared by winding a NiTi shape memory alloy wire into a spiral coil and then winding, laying or weaving, the spiral coil of the NiTi shape memory alloy wire in the preform is structurally embedded or interlocked with each other, and the alloy screen pipe material has a recovery strain of 43-83% at a temperature of 100-350° C. The material has excellent high-temperature tolerance, can achieve spontaneous expansion and deformation under high-temperature conditions, and generally has an ultrahigh recoverable strain. Its pore characteristic is a through-hole structure and a pore size is controllable, so that a filtration effect is ensured, and the preparation cost is relatively low.

### FIELD OF TECHNOLOGY

The present invention relates to a shape memory alloy, and in particular to an ultrahigh strain recovery shape memory alloy screen pipe material with high temperature resistance, and a preparation method and application thereof, and belongs to the technical field of sand control in oil and gas drilling and well completion.

### BACKGROUND

In downhole extraction of oil and gas resources, a substantial mixture of sand and gravel and clay is typically present. Particularly, a “sand production phenomenon” caused by the presence of sand and gravel severely compromises the extraction efficiency and the quality of oil and gas, prolongs an extraction cycle, induces irreversible downhole damage, and significantly reduces a total resource extraction volume of an oil and gas well.

Oil and gas extraction encompasses processes such as drilling, engineering construction, geophysical exploration, well logging and mud logging. The drilling refers to a process of penetrating formations to create a wellbore by using a drilling rig, thereby establishing connectivity between a ground surface and an underground oil reservoir. This process specifically includes procedures such as drilling fluid preparation, mud logging, well logging, cementing, and well completion. As the connection between “drilling engineering” and “extraction engineering”, the well completion can not only achieve the connection between an oil production pipe and an oil and gas reservoir, but also exert a certain sand control function. At present, there are two main well completion methods that can achieve sand control: gravel packed completion and mechanical expansion screen pipe completion. The gravel packed completion means that after drilling is completed, sand and gravel distributed with a certain size are pumped between a well wall and the oil production pipe of an oil production layer, and the sand and gravel are closely packed to form a filter layer. This method can not only filter an oil-sand mixture, but also achieve a certain support effect for the oil production pipe, and is most widely used at present. However, this well completion method requires pumping a large amount of the sand and gravel into the oil production layer, featuring a prolonged construction period and substantial workloads. The well with incomplete gravel packing is prone to a wellbore collapse. Additionally, gravitational settling of the sand and gravel makes it difficult to achieve complete envelopment of the oil production pipe in a horizontal well, rendering this method unsuitable for the horizontal well and complex well structures. A mechanical expansion screen pipe refers to a pipe used in such a way that an expandable screen pipe in a contracted state is lowered to a designated position such as the oil production layer after drilling is completed, after cement is injected to fix an entire expansion system, a special expansion tool, generally an expansion cone, is used to expand and deform the expansion system, and finally, a drill bit drills again to remove excess cement. This method can support the oil production pipe and has a certain filtration effect. However, this well completion method cannot achieve a tight fit between the oil production pipe and the well wall. The well wall at gaps is susceptible to sand and gravel impacts. In addition, a sand blocking effect is limited, and extremely high technical requirements are needed during application.

In this regard, Baker Hughes Oilfield Technology Service Company of the United States has developed an intelligent screen pipe material (i.e., a GeoFORM barrel assembly) based on a porous shape memory polymer (SMP) (Shape memory polyurethane foam for downhole sand control filtration devices, U.S. Pat. No. 7,926,565B2, 2011 Apr. 19; Variable Tg Shape memory Polyurethane for wellbore devices U.S. Pat. No. 8,365,833B2. 2013 Feb. 5). The assembly is mainly composed of a porous base pipe as an inner layer and a shape memory polymer as an outer layer. Before run-in, the outer polymer is in a compressed state (compressed by 50-80%), and spontaneously expands to its original shape in a downhole high-temperature environment, achieving spatial filling of wellbores with different diameters and perfect fitting and support for the well wall. At the same time, it blocks the sand and gravel through its pore structure to achieve filtration. Its pore size is generally 60-160 μm, and the filtration accuracy can reach 43 μm. The principle of spontaneous expansion of this material originates from a change of an internal state of the polymer. The polymer is deformed and its shape is constrained in a high-elastic state, and when the temperature decreases to a glassy state, the shape is maintained, and at this time the corresponding assembly is in the compressed state. After being lowered in the downhole high-temperature environment, the polymer transitions back to the high-elastic state, and through the shape memory effect, it spontaneously recovers its shape, achieving a perfect fitting of the oil production pipe to the wellbore. Combined with its pore structure, the material exhibits a dual function of supporting the oil production pipe, and blocking the sand and filtering. Currently, 70% of oil and gas wells are in high-temperature environments. This method can achieve spontaneous expansion in the high-temperature downhole. In addition, the operation is simple and the time cost can be reduced, so that it has great application prospects. However, the downhole high-temperature conditions are complex and changeable, and often exceed 100° C. or even reach 350° C. Due to the inherent characteristics and a shape recovery mechanism of the polymer (low glass transition temperature (Tg, generally below 100° C.)), its performance is unstable under high temperature (above 100° C.) and high pressure, and it is prone to creep deformation and large stress relaxation, and may even melt and fail. In addition, the assemblies of this technology are extremely expensive, and the cost of a single oil well can exceed one million US dollars.

### SUMMARY

In order to solve the above problems in an existing shape memory polymer intelligent screen pipe material used in a well completion operation, the present invention provides an ultrahigh strain recovery shape memory alloy screen pipe material and a preparation method thereof. The screen pipe material of the present invention has excellent high-temperature tolerance, can achieve spontaneous expansion and deformation under high-temperature conditions, and generally has an ultrahigh recoverable strain of over 43%. A pore characteristic of the material is a through-hole structure and a pore size is controllable, so that a filtration effect is ensured, and the preparation cost is relatively low.

Shape memory alloys (mainly including NiTi-based, Cu-based and Fe-based alloys) have high melting points and can be stably applied between 100-350° C. However, compared to a shape memory polymer, a maximum recoverable strain of the shape memory alloy caused by martensite phase transformation does not exceed 20%. It is possible to increase a compressive recoverable strain of a porous memory alloy by introducing pores into a dense memory alloy and reasonably regulating pore structures. However, at present, the porous memory alloys prepared by powder metallurgy, 3d printing, melt infiltration and other methods can only exhibit high recovery stress, while their compressive recoverable strain can never exceed the maximum recoverable strain of the dense shape memory alloy, falling short of meeting the requirement of the intelligent screen pipe material for a recoverable strain of over 30%.

The present invention adopts a NiTi shape memory alloy wire with a suitable wire diameter, and prepares a porous NiTi memory alloy wire entangled material (also known as metal rubber) with an ultrahigh recoverable strain by winding spiral coil, performing fixed-distance stretching, preparing a preform and performing cold pressing molding. This material is prepared by entangling the alloy wire. The special mesostructure endows the material with excellent elasticity. Combined with the shape memory effect of shape memory alloys achieved through the martensite phase transformation at high temperatures after deformation, the ultrahigh recoverable strain can be achieved generally.

The present invention can be realized by the following technical solution:
an ultrahigh strain recovery shape memory alloy screen pipe material is obtained by cold pressing molding of a preform, the preform is prepared by winding a NiTi shape memory alloy wire into a spiral coil and then winding, laying or weaving, the spiral coil of the NiTi shape memory alloy wire in the preform is structurally embedded or interlocked with each other, and the alloy screen pipe material has a recovery strain of 43-83% at a temperature of 100-350° C.

In order to further achieve the objective of the present invention, the NiTi shape memory alloy wire preferably has a titanium content of 49.6-56% in terms of an atomic ratio.

Preferably, the NiTi shape memory alloy wire is a single martensite phase or a composite phase of Ti₂Ni and B19′ martensite at room temperature.

Preferably, a diameter of the NiTi shape memory alloy wire is 0.05-0.5 mm.

Preferably, a porosity of the alloy screen pipe material is 45-81%, an average pore size is 51-500 μm, a recoverable strain reaches at least 43%, and a recovery stress is in a MPa level.

A preparation method for the ultrahigh strain recovery shape memory alloy screen pipe material includes the following steps:
1) winding to form a spiral coil: winding a cleaned NiTi shape memory alloy wire around a mandrel to form the spiral coil;
2) preparing a preform: winding, laying or weaving the obtained spiral coil to prepare the preform, wherein the spiral coil of the NiTi shape memory alloy wire in the preform is structurally embedded or interlocked with each other; and
3) performing cold pressing molding: placing the preform into a mold for cold pressing molding to obtain the ultrahigh strain recovery shape memory alloy screen pipe material.

Preferably, before winding, laying or weaving the obtained spiral coils to prepare the preform, the preparation method further comprises stretching the spiral coil so that a ratio of a pitch of the stretched spiral coil to a mean diameter of the spiral coil is (0.95:1) to (1.05:1); a ratio of a height of the preform to a height of a sample obtained after the cold pressing molding is necessarily controlled between (2:1) to (7:1); and the cleaning is to remove oil stains on a surface of the NiTi shape memory alloy wire.

Preferably, a solution adopted for the cleaning is a 95% alcohol solution, and a method for cleaning is ultrasonic cleaning, and cleaning time is 10-30 min.

Preferably, a diameter of the mandrel is 0.5-4 mm, and the metal mandrel is stainless steel; and a ratio of the diameter of the mandrel to a diameter of the alloy wire is controlled to be 5−(15:1); and

a loading rate of the cold pressing molding is 1-5 mm/min, a pressure for cold pressing is 2-80 kN, displacement loading control is adopted, and pressure holding time is 10-60 min.

The present invention provides an application of the ultrahigh strain recovery shape memory alloy screen pipe material in sand control for oil and gas drilling and well completion.

Metal rubber, which has a unique pore structure and excellent damping and recovery characteristics, is a type of porous metal material prepared through winding, entangling, and compression molding of metal wires. The screen pipe material of the present invention is porous memory alloy rubber prepared by the NiTi shape memory alloy wires. The material has both an excellent recovery characteristic of the metal rubber (also referred to as structural recovery, with a maximum recovery strain of up to 20%) and the shape memory effect of the shape memory alloy (also referred to as martensite phase transformation recovery, with a maximum recovery strain of 8% for a dense NiTi memory alloy). The linear superposition of these two effects results in a maximum recoverable strain of no more than 30% currently, which fails to meet the application requirement of the shape memory polymer screen pipe material that demands the ultrahigh recovery strain (at least over 30%). In the present invention, a coupling effect of the structure recovery (pore structure) and the phase transformation recovery (the martensite phase transformation) is used to modulate the ultrahigh recoverable strain (43%-83%) for the first time. For example, a residual stress is applied to the martensite phase transformation by optimizing a winding angle, and the Ti₂Ni phase-enhanced B19′ martensite phase structure is obtained by adjusting the NiTi composition, so as to enable the porous memory alloy rubber to exhibit the excellent recovery characteristic at high temperatures. The pore size and the filtration accuracy can be adjusted by changing the wire diameter and the porosity to meet the corresponding filtration accuracy requirements in oil and gas extraction.

The screen pipe material of the present invention is composed of intertangled NiTi shape memory alloy wires. Gaps between the wires form interconnected pores within the material. The pore size can be controlled either by adjusting a volume percentage of the alloy wire (i.e., modifying the porosity) or by adjusting the wire diameter of the alloy wire. It should be noted that reciprocating winding is only to achieve the embedding and interlocking of the wires, and there are various ways, such as entanglement, weaving, laying, and so on. The spiral coil is made to keep the mesostructure inside the material in a spiral coil state. Maintaining this uniform structure can achieve good embedding and interlocking to ensure stability, so that the material has the excellent recoverable strain.

### BENEFICIAL EFFECTS

Compared with the prior art, the present invention has the following advantages and beneficial effects.
(1) The screen pipe filter material of the present invention, which is prepared by winding the NiTi shape memory alloy wire into a spiral coil shape and then tangling the obtained spiral coil, has excellent elasticity at room temperature, and can achieve the phase transformation recovery at high temperatures combined with the shape memory effect of the memory alloy; in particular, the ultrahigh recoverable strain can be achieved through the coupling effect of the pore structure and martensite phase transformation, and generally, the material has a compressive recoverable strain of over 43% at high temperatures (100-350° C.). No method has been found yet to directly wind or braid the NiTi shape memory alloy wire to achieve a relatively high compressive recoverable strain at high temperatures without first forming the wire into the spiral coil.
(2) The screen pipe material of the present invention is itself obtained by tangling the NiTi shape memory alloy wires, and the NiTi alloy has good high-temperature stability (100-350° C.), corrosion resistance and pressure resistance characteristics, which endows the screen pipe material of the present invention with the advantages of excellent high-temperature resistance, weather resistance and long service life, so that the screen pipe material is particularly suitable for almost all oil and gas wells (especially oil and gas extraction operations at sea or in harsh environments), and can significantly improve the sand retaining effect, enhance the recovery efficiency and the quality of oil and gas.
(3) The screen pipe material of the present invention is simple in preparation process due to the fact that the screen pipe material is prepared by winding the coils, performing the fixed-pitch stretching, preparing the preform and performing the cold pressing molding by using the suitable alloy wires, so that the reliability is high and mass production is achieved easily.

### DESCRIPTION OF THE DRAWINGS

FIG. 1 is a flow chart of a preparation method of an ultrahigh strain recovery shape memory alloy screen pipe material;

FIG. 2 is an intuitive schematic diagram of a preparation process of the ultrahigh strain recovery shape memory alloy screen pipe material (preparation of a preform by reciprocating winding);

FIG. 3 is a macroscopic optical photograph of the preform and a cylindrical sample obtained by cold pressing in the preparation process of the ultrahigh strain recovery shape memory alloy screen pipe material (preparation of the preform by reciprocating winding);

FIG. 4 is a DSC curve of a NiTi equal atomic ratio (containing 50 at. % of titanium) shape memory alloy wire with a wire diameter of 0.3 mm in Example 1;

FIG. 5 is a cyclic compression curve of a sample with a wire diameter of 0.3 mm and a porosity of 69.7% in Example 1 under compressive strains of 20%, 30%, 40% and 50%;

FIG. 6 is a pore size distribution curve of the sample with the wire diameter of 0.3 mm and the porosity of 69.7% in Example 1;

FIG. 7 is a working principle diagram of in-situ expansion, sand blocking and fluid infiltration after the ultrahigh strain recovery shape memory alloy screen pipe material is combined with a porous base pipe;

FIG. 8 is an industrial CT photograph of a sample with a wire diameter of 0.3 mm and a porosity of 77.5% in Example 2;

FIG. 9 is a 65% compressive stress-strain curve of the sample with the wire diameter of 0.3 mm and the porosity of 77.5% in Example 2;

FIG. 10 is a pore size distribution curve of the sample with the wire diameter of 0.3 mm and the porosity of 77.5% in Example 2;

FIG. 11 is an intuitive schematic diagram of a preform prepared by a laying method employed in Example 3 and a macroscopic optical photograph of the preform and the final cylindrical sample;

FIG. 12 is a 50% compressive stress-strain curve of a sample with a wire diameter of 0.3 mm and a porosity of 72.5% in Example 3;

FIG. 13 is a pore size distribution curve of the sample with the wire diameter of 0.3 mm and the porosity of 72.5% in Example 3;

FIG. 14 is a scanning electron micrograph of a NiTi (containing 54 at. % titanium) alloy structure (Ti₂Ni reinforced NiTi—B19′ phase) in Example 4;

FIG. 15 is a pore size distribution curve of a sample with a wire diameter of 0.3 mm and a porosity of 73.3% in Example 4;

FIG. 16 is a DSC curve of a Ti-rich NiTi (containing 56 at. % titanium) shape memory alloy wire with a wire diameter of 0.5 mm in Example 5;

FIG. 17 is a 50% compressive stress-strain curve of a sample with a wire diameter of 0.5 mm and a porosity of 57.5% in Example 5; and

FIG. 18 is a pore size distribution curve of the sample with the wire diameter of 0.5 mm and the porosity of 57.5% in Example 5.

### DESCRIPTION OF THE EMBODIMENTS

In order to better understand the present invention, the present invention will be further described below with reference to examples and accompanying drawings, but the implementation of the present invention is not limited thereto.

### Example 1

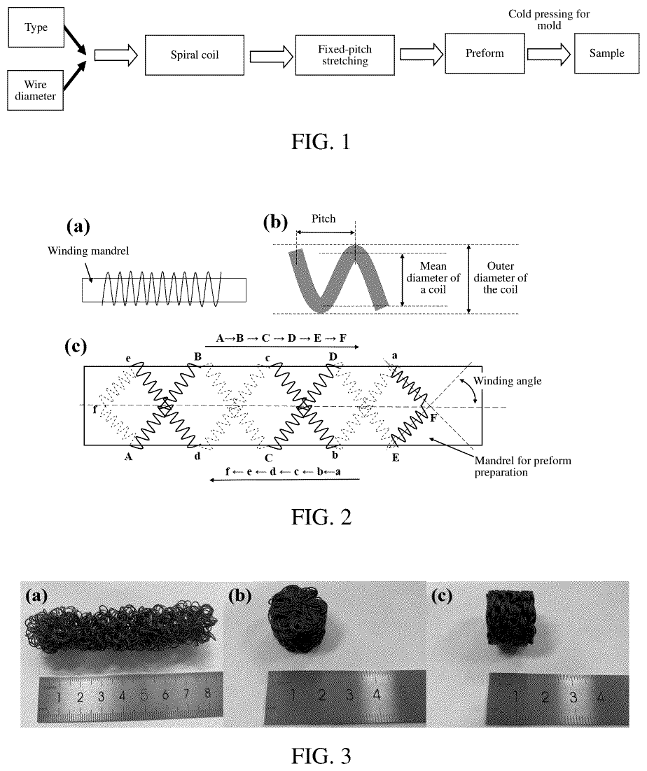

FIG. 1 is a preparation flow chart of an ultrahigh strain recovery shape memory alloy screen pipe material. It can be seen from FIG. 1 that a preparation method of the ultrahigh strain recovery shape memory alloy screen pipe material includes the following steps:
(1) selecting a NiTi equal atomic ratio (containing 50 at. % titanium) shape memory alloy wire with a wire diameter of 0.3 mm, a wire length of 8.64 m and a mass of 3.94 g, and placing it in a 95% alcohol solution for ultrasonic treatment at 25° C. for 10 minutes to remove oil stains on a surface of the alloy wire.
(2) winding the NiTi memory alloy wire cleaned in the step (1) into a spiral coil around a 304 stainless steel mandrel with a diameter of 1.5 mm, wherein an outer diameter of the spiral coil after winding is 2.55 mm, and a ratio of the outer diameter of the spiral coil to the diameter of the metal wire is 8.5:1.
(3) subjecting the spiral coil wound in the step (2) to fixed-pitch stretching so that a pitch after stretching is equal to a mean diameter of the spiral coil (i.e., the pitch is 2.25 mm).
(4) by taking a 304 stainless steel rod with a diameter of 1.5 mm as a mandrel, winding the spiral coil subjected to the fixed-pitch stretching in the step (3) around the mandrel starting from a middle part of the mandrel to its edge unidirectionally at a winding angle of 60 degrees as shown in (c) of FIG. 2, continuously performing reciprocating winding in directions A→B→C→D→E→F and a→b→c→d→e→f in turn until the coil is wound to its end, and finally embedding the end of the coil inside for end sealing to obtain a preform with a length of 41.2 mm and a diameter of slightly less than 12 mm.
(5) placing the preform prepared in the step (4) in a cylindrical mold with an inner diameter of 12 mm, and performing cold pressing molding at a loading rate of 5 mm/min under conditions that displacement control loading is adopted, a pressure for cold pressing is 8 kN and the pressure is held for 30 min, so that a cylindrical ultrahigh strain recovery shape memory alloy screen pipe material is obtained, and a finally obtained sample has a height of 17.79 mm.

FIG. 2 is an intuitive schematic diagram of a preparation process of the ultrahigh strain recovery shape memory alloy screen pipe material, where (a) in the figure is an intuitive schematic diagram of forming the spiral coil in the step (2); (b) in the figure is an intuitive schematic diagram of the spiral coil obtained after the fixed-pitch stretching in the step (3), which shows intuitive marks of the outer diameter of the coil, the mean diameter of the coil and the pitch, the pitch being equal to the mean diameter of the coil; and (c) in the figure is a schematic diagram of the preform prepared by reciprocating winding in the step (4), which shows an intuitive diagram of the winding angle, that is, an included angle between the coil and the mandrel.

FIG. 3 is a macroscopic optical photograph of the preform and the sample in a sample preparation process, where (a) in the figure is the preform, and (b) and (c) in the figure are macroscopic optical photographs of a bottom surface and a side surface of the final cold-pressed cylindrical sample respectively.

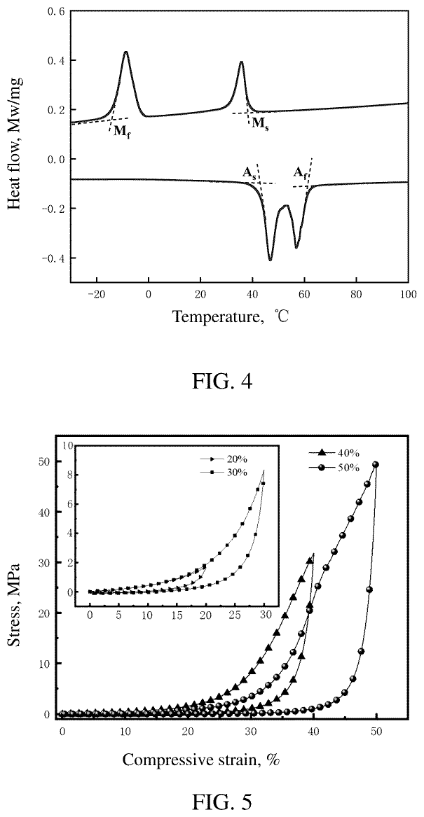

FIG. 4 shows DSC data of the NiTi equal atomic ratio (containing 50 at. % titanium) shape memory alloy wire with the wire diameter of 0.3 mm, where the M_{f}, Mₛ, Aₛ and Aᵣ temperatures are −13.3° C., 38.6° C., 54.13° C. and 61.4° C., respectively, and the alloy wire is a single B19′ martensite phase at the room temperature after being quenched.

The mass m, diameter D and height H of the sample prepared by the step (5) are measured and recorded, V is an apparent volume of the sample, and it is known that a density of the NiTi shape memory alloy wire is ρₛ=6.45 g/cm³. The porosity P of the sample is calculated by the following formula, where ρ̅ is a relative density, and the calculated porosity P=69.7%.

$$\overline{ρ} = \frac{m}{V {ρ}_{s}} = \frac{m}{\frac{π}{4} {D}^{2} H {ρ}_{s}} = \frac{4 m}{π {D}^{2} H {ρ}_{s}}$$

$$P = 1 - \overline{ρ} = 1 - \frac{4 m}{π {D}^{2} H {ρ}_{s}}$$

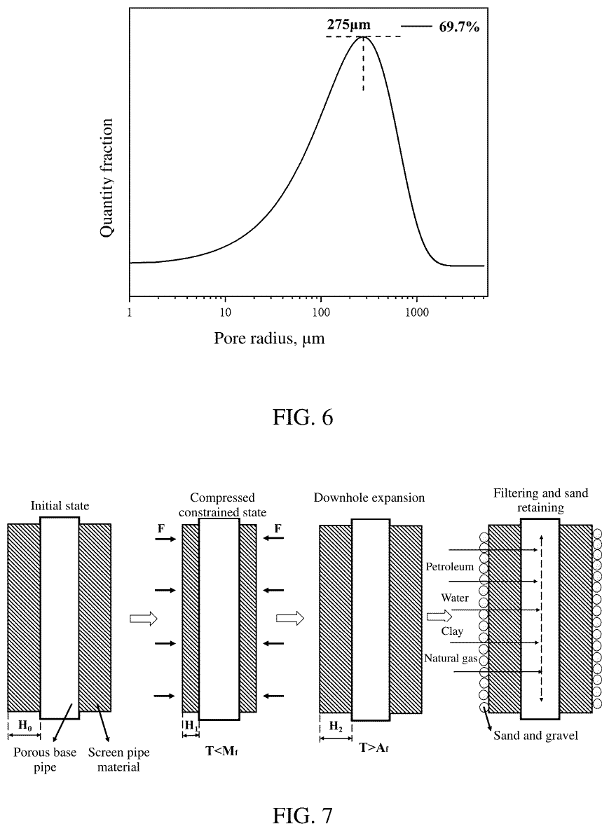

The sample prepared by the step (5) is subjected to a compression test at room temperature according to the ASTM E9-89a standard. Test equipment is an INSTRON 5984 universal material testing machine. The compression performance test is carried out under 20%, 30%, 40% and 50% compressive strains in turn by adopting displacement control loading at a loading rate of 0.5 mm/min. Test results are shown in FIG. 5. It can be seen from FIG. 5 that stress values of the sample at 20%, 30%, 40% and 50% strains are 1.71 MPa, 8.36 MPa, 31.80 MPa and 49.79 MPa, respectively. After the loading of the 20%, 30% and 40% compressive strains, the shape of the sample can fully return to a state when the compressive strains are not loaded, which indicates that a recoverable strain of the sample reaches 40%, far exceeding a maximum recoverable strain of the NiTi shape memory alloy itself. After a 50% pre-strain is loaded, the measured elastic strain (structural recovery) of the sample is 38.6%, with a residual strain of 11.4%, which is due to the irreversible rearrangement of a mesostructure of the material, that is, an arrangement state of the wire, under the loaded large strain; by observing loading sections of 40% and 50% strains, it is found that they do not coincide, and it can be judged that there is a certain rearrangement between the wires when the material is loaded with the 40% strain, but this part of rearrangement is reversible, and this reversible rearrangement leads to the weakening of the structure, so that a curve of the subsequent loading section at the 50% strain is obviously lower than that of the previous loading section. After the sample is subjected to the 50% compressive strain, the sample is placed in a water bath at 95° C. for one hour, producing a phase change-driven rebound strain (phase transformation recovery) of 16.4%, with its recoverable strain (i.e., a sum of the structural recovery and the phase transformation recovery) reaching 55.0%. Test results of a pore size distribution of this sample are shown in FIG. 6, and its pore size is 100-500 μm and an average pore size is 275 μm.

Although a shape memory polymer material currently applied in the screen pipe can also reach the recoverable strain of 55.0% under downhole high temperature conditions, due to properties of the polymer material itself which has poor mechanical properties at high temperatures and is prone to stress relaxation and a creep phenomenon, the application of this kind of materials is greatly limited by a complex high temperature and high pressure environment downhole.

If the ultrahigh strain recovery shape memory alloy screen pipe material prepared in this example is combined with a porous base pipe, and placed in a high temperature well under the constriction of the compressive strain of 50%, in combination with the excellent elasticity of its structure and a shape memory effect of the shape memory alloy at the high temperature, the recoverable strain of up to 55.0% can be achieved. The NiTi shape memory alloy has stable mechanical properties at high temperatures. After the shape recovery, the material is in an austenite phase state. This phase structure has an elastic modulus higher than that of a martensite phase at the room temperature, so that it has extremely stable mechanical properties at high temperatures and can completely overcome many shortcomings of the above shape memory polymer at the high temperatures.

At present, the elasticity of metal rubber prepared from a stainless steel wire, a Ni-based super alloy, an aluminum wire and so on is less than 20%, while a shape memory effect of a porous shape memory alloy cannot reach the performance in a dense state. Taking NiTi as an example, it is difficult to reach 8%. The linear superposition of the above two cannot reach a recoverable strain of 30%. In this example, a coupling effect of the structural recovery (a pore structure) and the phase transformation recovery (the martensite phase transformation) is used for the first time to modulate shape memory alloy rubber with an ultrahigh recovery strain of 55.0%, which can exhibit excellent recovery characteristics at high temperatures. A thickness direction is a height direction of the sample in Example 1.

As shown in FIG. 7, the ultrahigh strain recovery shape memory alloy screen pipe material obtained in this example is combined with the porous base pipe, that is, the obtained screen pipe material (the ultrahigh strain recovery shape memory alloy screen pipe material, the porous shape memory alloy rubber) is directly prepared into a pipe which is mounted around an outer periphery of the porous base pipe, and an initial thickness is H₀ when the screen pipe material is not deformed; in a low temperature martensite phase state (T<M_{f}), a load is applied to the screen pipe material to deform and constrain its shape, and a thickness of the screen pipe material after compression deformation is H₁; then, a porous base pipe and screen pipe material assembly is lowered into a well which is under a high temperature condition (T>A_{f}), and through the coupling effect of the structural recovery (pore structure) and the phase transformation recovery (martensite phase transformation) of the screen pipe material, a great strain recovery can be realized, and a recovered thickness H2 of the recovered screen pipe material exceeds the initial thickness H0 of the screen pipe material.

At present, a GeoFORM assembly can achieve a recoverable strain of 30% downhole, while the screen pipe material prepared in this example achieves the recoverable strain of 55%, and the recovery performance has fully met the needs of downhole. Meanwhile, this screen pipe material, composed of the NiTi shape memory alloy wire, can still maintain extremely stable and excellent mechanical properties in a downhole high temperature environment, so that the disadvantage that mechanical properties of the porous shape memory polymer used in the GeoFORM assembly are sharply weakened at high temperature is greatly overcome. In addition, the mesostructure inside the screen pipe material after the shape recovery (that is, expansion) is still the entangled alloy wire, and a stable through-hole pore structure is maintained. This stable and unique pore structure can ensure that oil and gas can smoothly enter an oil production pipe through the screen pipe material and the porous base pipe, and at the same time the sand and gravel can be effectively blocked.

### Example 2

A preparation method of an ultrahigh strain recovery shape memory alloy screen pipe material includes the following steps:
(1) selecting a NiTi (containing 51 at. % titanium) shape memory alloy wire with a wire diameter of 0.3 mm, a wire length of 7.5 m and a mass of 3.42 g, and placing the wire in 95% alcohol for ultrasonic treatment at 25° C. for 20 minutes to remove oil stains on a surface of the alloy wire;
(2) winding the NiTi shape memory alloy wire cleaned in the step (1) into a spiral coil around a No. 45 steel mandrel with a diameter of 2.1 mm, wherein an outer diameter of the wound coil is 3.15 mm, and a ratio of the diameter of the spiral coil to the diameter of the metal wire is 10.5:1.
(3) subjecting the spiral coil wound in the step (2) to fixed-pitch stretching so that a pitch after stretching is 0.95 of the mean diameter of the spiral coil (i.e., the pitch is 2.71 mm).
(4) by taking a No. 45 steel rod with a diameter of 2.1 mm as a mandrel, winding the spiral coil subjected to the fixed-pitch stretching in the step (3) around the mandrel starting from a middle part of the mandrel to its edge unidirectionally at a winding angle of 45 degrees as shown in (c) of FIG. 2, continuously performing reciprocating winding in directions A→B→C→D→E→F and a→b→c→d→e→f in turn, and finally embedding a end of the coil into a preform for end sealing to obtain the preform with a length of 45.3 mm and a diameter of slightly less than 12 mm.
(5) placing the preform prepared in the step (4) in a cylindrical mold with an inner diameter of 12 mm, performing cold pressing molding at a loading rate of 3 mm/min under conditions that displacement control loading is adopted, a holding pressure for cold pressing is 2 kN and the pressure is held for 10 minutes, so that an ultrahigh strain recovery shape memory alloy screen pipe material is obtained, and a final sample has a height of 20.83 mm and a porosity of 77.5%.

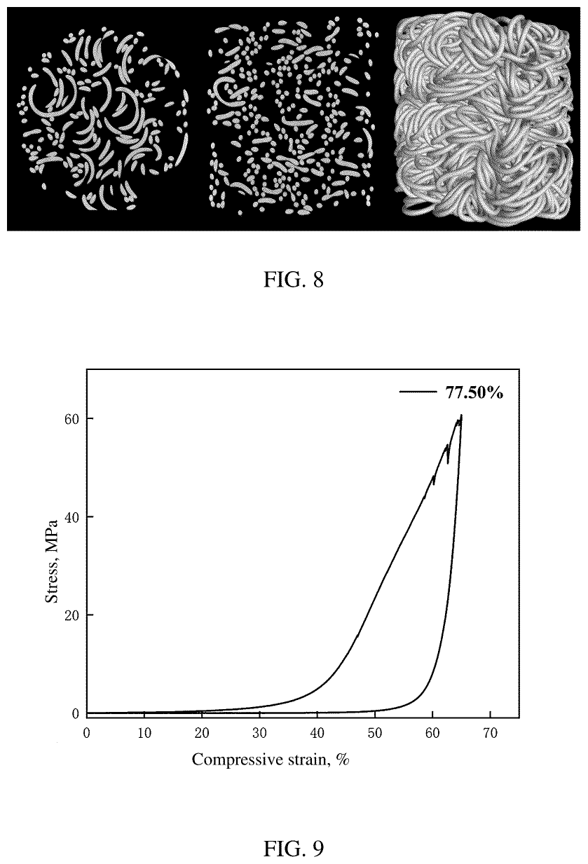

A three-dimensional structure of the sample is characterized by industrial CT, and results are shown in FIG. 8. It can be seen from FIG. 8 that wires inside the sample are well interlocked with each other, and the metal wires in a cross section and at a bottom surface also show a uniform distribution state.

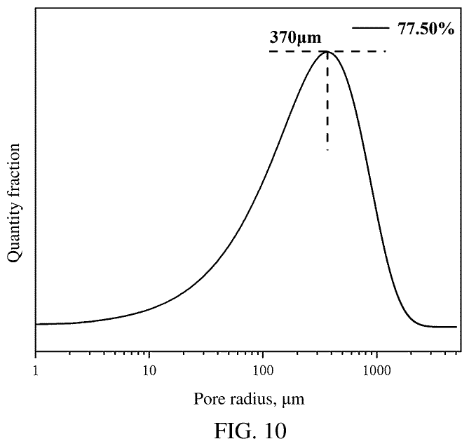

The sample is subjected to the compression test at room temperature according to the ASTME9-89a standard. The test equipment is the INSTRON 5984 universal material testing machine. The sample is directly subjected to a loading and unloading test under a compressive strain of 65% by adopting displacement control loading at a loading rate of 0.5 mm/min. Test results are shown in FIG. 9. It can be seen from FIG. 9 that the corresponding stress of the sample under the compressive strain of 65% is 60.69 MPa, the curve remains smooth in early and middle periods of the loading, and a small wavy section begins at a strain of around 60% strain, which is caused by friction and sliding of the wires inside the sample during compression. When the sample is loaded with the compressive strain of 65%, the corresponding height is 7.29 mm. After the external load is unloaded, due to the elasticity given by a metal rubber structure, the height size of the sample naturally rebounds to 15.21 mm, and the rebounded size reaches 7.92 mm. The rebound strain of this kind of structure is defined as a structural recovery strain of the material. After calculation, the structural recovery strain of the sample is 38.0%, and there is a residual strain of 27.0%; based on the shape memory effect of the shape memory alloy, the above sample is placed in an environment above A_{f} temperature for a period of time, i.e. the sample is treated in a water bath at 95° C. for one hour. The sample size is changed from 15.21 mm to 22.09 mm, and the rebounded size reaches 6.88 mm. This kind of rebound is defined as a phase transformation recovery strain caused by the martensite phase transformation. After calculation, the strain reaches 33.0%, far exceeding the maximum recoverable strain 8% of the dense NiTi alloy. The recoverable strain of the sample reaches 71.0%, which exceeds the compressive strain of 65% under preloading. Its data is shown in Table 1 below. Pore size distribution data of this sample is shown in FIG. 10, and its pore size is 200-700 μm and the average pore size is 370 μm.

TABLE 1

| | | | Phase | |
|---|---|---|---|---|
| | | | transfor- | |
| | Structural | Residual | mation | Recoverable |
| Porosity | recovery | strain | recovery | strain |
| 77.5% | 38.0% | 27.0% | 33.0% | 71.0% |

### Example 3

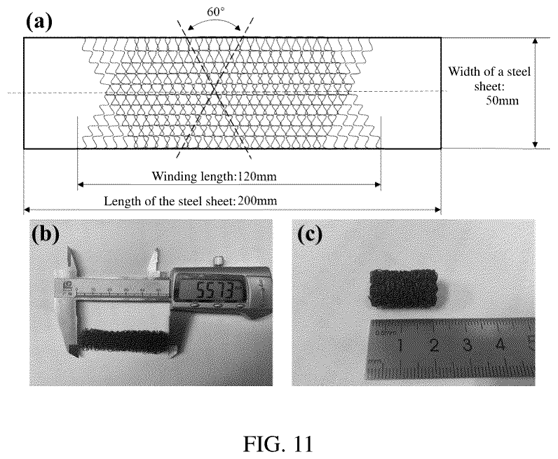

A preparation method of an ultrahigh strain recovery shape memory alloy screen pipe material includes the following steps:
(1) selecting a NiTi (containing 51 at. % titanium) shape memory alloy wire with a wire diameter of 0.3 mm, a wire length of 9 m and a mass of 4.13 g, and placing the wire in 95% alcohol for ultrasonic treatment at 25° C. for 20 minutes to remove oil stains on a surface of the alloy wire;
(2) winding the NiTi shape memory alloy wire cleaned in the step (1) into a spiral coil around a No. 45 steel mandrel with a diameter of 1.5 mm, wherein an outer diameter of the wound coil is 2.55 mm, and a ratio of the diameter of the spiral coil to the diameter of the metal wire is 8.5:1.
(3) subjecting the spiral coil wound in the step (2) to fixed-pitch stretching so that a pitch after stretching is equal to a mean diameter of the spiral coil (i.e., the pitch is 2.71 mm), and quantitatively dividing the stretched spiral coil into two parts, wherein a mass ratio of the first part to the second part is 8:1.
(4) sequentially winding the first part of spiral coil obtained in the step (3) obliquely around a stainless steel rectangular sheet with a length of 200 mm, a width of 50 mm and a thickness of 1 mm, wherein a winding length of a first layer is about 120 mm, and a second layer and subsequent layers of coil are laid at an angle of 60 degrees relative to a center line of the previous layer of spiral coil until the coil is wound completely, as shown in (a) of FIG. 11.
(5) removing a blank obtained in the step (4), rolling the blank into a cylindrical blank along a length direction, then evenly winding the second part of spiral coil around the cylindrical blank at a winding angle of 60 degrees as shown in (c) of FIG. 2, and finally, inserting an end of the coil into the blank for end sealing to obtain a near-cylindrical preform with a diameter of about 12 mm and a height of 55.7 mm, wherein a macroscopic optical picture of the preform is shown in (b) of FIG. 11.
(6) placing the preform prepared in the step (5) in a cylindrical mold with an inner diameter of 12 mm, performing cold pressing molding at a loading rate of 3 mm/min under conditions that displacement control loading is adopted, and a holding pressure for cold pressing is 5 kN and is held for 10 minutes, so that an ultrahigh strain recovery shape memory alloy screen pipe material is obtained, as shown in (c) of FIG. 11, and a final sample has a height of 20.6 mm and a porosity of 72.5%.

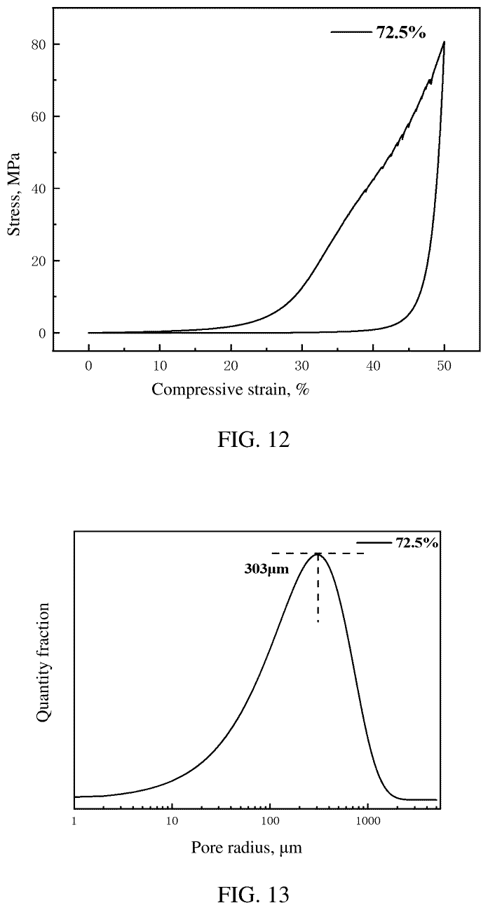

The sample is subjected to a 50% compressive strain test according to the ASTM E9-89a standard, and a loading rate is 0.5 mm/min. A compressive mechanical property curve is shown in the figure. As can be seen from FIG. 12, a loading curve keeps a relatively smooth state as a whole, and a small wavy section begins at around 37% strain, which is caused by friction and sliding of the wires inside the sample during compression. After the strain is unloaded, the height of this sample naturally rebounds to 16.8 mm, corresponding to a structural recovery of 31.5% and a residual strain of 18.5%. The sample is placed in an environment above A_{f} for a period of time (treated in the water bath at 95° C. for 1 hour), and the height of the sample is finally stabilized at 19.23 mm, corresponding to a phase transformation recovery strain of 11.8%, and a recoverable strain of 43.3% overall under high temperature conditions. Its data is shown in Table 2 below. Pore size distribution data of this sample is shown in FIG. 13, and its pore size is 150-600 μm and the average pore size is 303 μm.

TABLE 2

| | | | Phase | |
|---|---|---|---|---|
| | | | transfor- | |
| | Structural | Residual | mation | Recoverable |
| Porosity | recovery | strain | recovery | strain |
| 72.5% | 31.5% | 18.5% | 11.8% | 43.3% |

A preparation method of an ultrahigh strain recovery shape memory alloy screen pipe material includes the following steps:

### Example 4

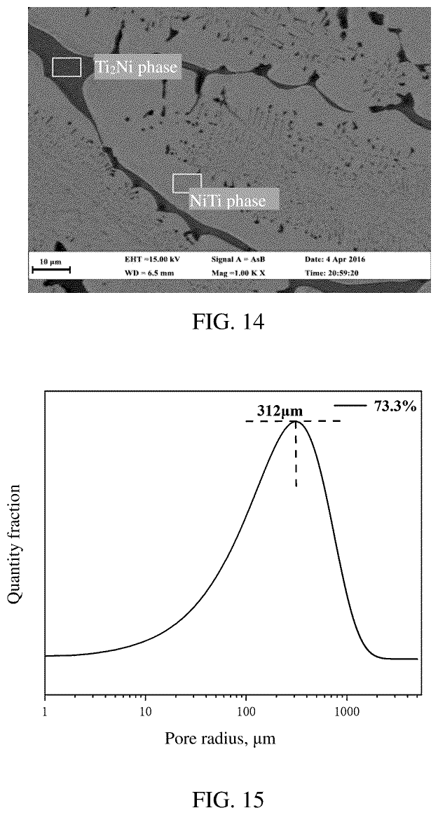

(1) selecting a NiTi (containing 54 at. % titanium) shape memory alloy wire with a wire diameter of 0.3 mm, a wire length is 6.0 m and a mass of 2.74 g, and placing the wire in 95% alcohol for ultrasonic treatment at 25° C. for 15 minutes to remove oil stains on a surface of the alloy wire, wherein a mesostructure of the alloy wire is a Ti₂Ni phase-reinforced B19′ martensite phase (as shown in FIG. 14, a light color represents a Ti₂Ni phase, and a dark color represents a NiTi—B19′ phase);
(2) winding the NiTi shape memory alloy wire cleaned in the step (1) into a spiral coil around a 201 stainless steel mandrel with a diameter of 3.5 mm, wherein an outer diameter of the wound coil is 4.35 mm, and a ratio of the diameter of the spiral coil to the diameter of the metal wire is 14.5:1.
(3) subjecting the spiral coil wound in the step (2) to fixed-pitch stretching so that a pitch after stretching is 1.05 of a mean diameter of the spiral coil (i.e., the pitch is 4.25 mm).
(4) by taking a 201 stainless steel rod with a diameter of 3.5 mm as a mandrel, winding the spiral coil subjected to the fixed-pitch stretching in the step (3) around the mandrel starting from a middle part of the mandrel to its edge unidirectionally at a winding angle of 30 degrees as shown in (c) of FIG. 2, continuously performing reciprocating winding in directions A→B→C→D→E→F and a→b→c→d→e→f in turn, and finally embedding an end of the coil into a preform for end sealing to obtain a preform with a length of 32.6 mm and a diameter of slightly less than 12 mm.
(5) placing the preform prepared in the step (4) in a cylindrical mold with an inner diameter of 12 mm, performing cold pressing molding at a loading rate of 2 mm/min under conditions that displacement control loading is adopted, a pressure for cold pressing is 4 kN and the pressure is held for 30 minutes, so that an ultrahigh strain recovery shape memory alloy screen pipe material is obtained, and a final sample has a height of 14.07 mm and a porosity of 73.3%.
   The height of the sample is compressed to 7.14 mm, i.e. a compressive strain of 49.3% is applied and constrained for 24 h. After the applied load is removed, the height of the sample spontaneously rebounds to 12.18 mm, and the sample is placed in a water bath at 95° C. for 1 h, 2 h and 5 h, and the sample sizes reach 16.87 mm, 17.52 mm and 18.87 mm respectively. After calculation, the strain data are as follows in Table 3:

TABLE 3

| | | | 1 h phase | 2 h phase | 5 h phase |
|---|---|---|---|---|---|
| | | | transfor- | transfor- | transfor- |
| | Structural | Residual | mation | mation | mation |
| Porosity | recovery | strain | recovery | recovery | recovery |
| 73.3% | 35.8% | 13.5% | 33.1% | 38.0% | 47.5% |

Through this constraint experiment, it can be known that a long-term stress constraint will not lead to the deterioration of the resilience performance of this ultrahigh strain recovery shape memory alloy screen pipe material. After the long-term constraint in this sample, it can also achieve recovery far beyond a pre-loaded deformation. After heat treatment for 5 h, the recoverable strain reaches 83.3%. This characteristic is in line with a practical application background of this material. The shape memory alloy screen pipe material enters the well under the pressure constraint and then expands spontaneously, as shown in FIG. 7. Pore size distribution data of this sample is shown in FIG. 15, and its pore size is 180-680 μm and the average pore size is 312 μm. By comparing with the pore sizes of the samples of Examples 1, 2 and 3, it can be easily found that the pore size of the material decreases with the decreasing porosity in the case of using the same wire diameter, and it is calculated that the average pore size of the sample with the wire diameter of 0.3 mm can be decreased to 128 μm when the porosity is 35%.

### Example 5

A preparation method of an ultrahigh strain recovery shape memory alloy screen pipe material includes the following steps:
(1) selecting a Ti-rich NiTi (containing 56 at. % titanium) shape memory alloy wire with a wire diameter of 0.5 mm, a wire length of 12.0 m and a mass of 13.84 g, and placing the wire in 95% alcohol for ultrasonic treatment at 25° C. for 20 minutes to remove oil stains on a surface of the alloy wire, wherein a mesostructure of the alloy wire is a Ti₂Ni phase-reinforced B19′ martensite phase;
(2) winding the NiTi shape memory alloy wire cleaned in the step (1) into a spiral coil around a No. 20 steel mandrel with a diameter of 3 mm, wherein an outer diameter of the wound coil is 4.81 mm, and a ratio of the diameter of the spiral coil to the diameter of the metal wire is 9.62:1.
(3) subjecting the spiral coil wound in the step (2) to fixed-pitch stretching so that a pitch after stretching is equal to a mean diameter of the spiral coil (i.e., the pitch is 4.31 mm).
(4) by taking a No. 20 steel rod with a diameter of 3 mm as a mandrel, performing reciprocating winding of the spiral coil subjected to the fixed-distance stretching in the step (3) around the mandrel, at an angle of 60 degrees, to obtain a preform having a length of 51.7 mm. The specific process is as follows:
by taking the No. 20 steel rod with the diameter of 3 mm as the mandrel, winding the spiral coil subjected to the fixed-pitch stretching in the step (3) around the mandrel starting from a middle part of the mandrel to its edge unidirectionally at a winding angle of 60 degrees as shown in (c) of FIG. 2, continuously performing reciprocating winding in directions A→B→C→D→E→F and a→b→c→d→e→f in turn, and finally embedding the end of the coil into the preform for end sealing to obtain the preform with a length of 51.7 mm and a diameter of slightly less than 20 mm.
(5) placing the preform prepared in the step (4) in a cylindrical mold with an inner diameter of 20 mm, performing cold pressing molding at a loading rate of 3 mm/min under conditions that displacement control loading is adopted, a pressure for cold pressing is 60 kN and the pressure is held for 30 minutes, so that an ultrahigh strain recovery shape memory alloy screen pipe material is obtained, and a final sample has a height of 14.20 mm and a porosity of 57.5%.

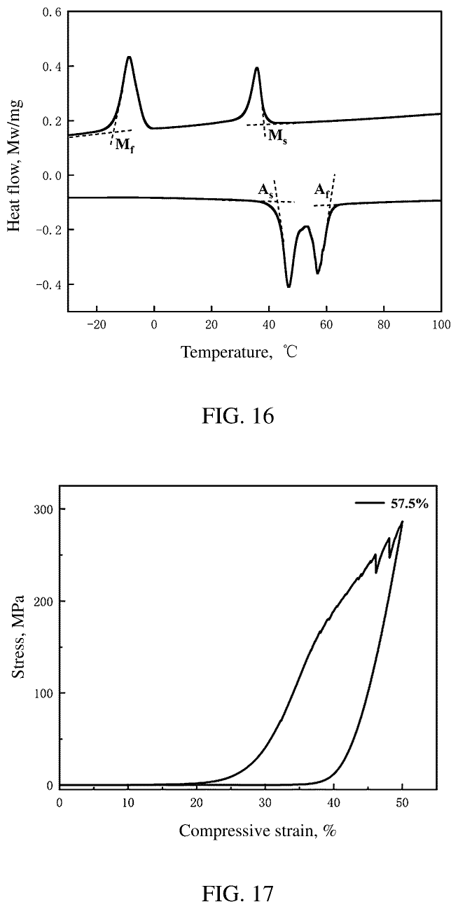

FIG. 16 shows DSC data of the Ti-rich NiTi (containing 56 at. % titanium) shape memory alloy wire with the wire diameter of 0.5 mm, where Mf, Ms, As and Af temperatures are 12.1° C., 33.8° C., 54.1° C. and 85.8° C., respectively, and the composition of the material phase at room temperature is determined as a Ti2Ni and B19′ martensite composite phase by XRD characterization.

The sample is subjected to a 50% compressive strain test according to the ASTM E9-89a standard, and a loading rate is 0.5 mm/min. A compressive mechanical property curve is shown in FIG. 17. As can be seen from FIG. 17, a loading curve keeps a relatively smooth state as a whole, and a wavy section begins at around 45% strain, which is caused by friction and sliding of the wires inside the sample during compression. After the strain is unloaded, this sample naturally rebounds to 12.20 mm, corresponding to a structural recovery of 35.9% and a residual strain of 14.1%. The sample is placed in an environment above A_{f} for a period of time (treated in the water bath at 95° C. for 1 h), and the height of the sample is finally stabilized at 15.60 mm, corresponding to a phase transformation recovery strain of 23.9%, and a recoverable strain of 59.8% overall under high temperature conditions. Its data is shown in Table 4 below.

TABLE 4

| | | | Phase | |
|---|---|---|---|---|
| | | | transfor- | |
| | Structural | Residual | mation | Recoverable |
| Porosity | recovery | strain | recovery | strain |
| 57.5% | 35.9% | 14.1% | 23.9% | 59.8% |

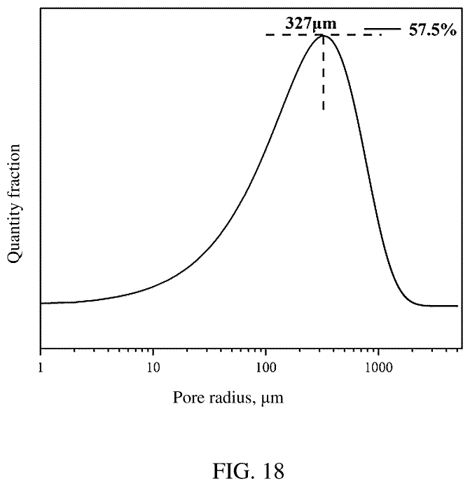

The pore size distribution of this sample is shown in FIG. 18, and its pore size is 180-680 μm, and the average pore size is 327 μm. Comparing this data with that in Example 4, it can be found that the pore size of the sample with the thick wire diameter and the low porosity can be equivalent to that of the sample with the thin wire diameter and the high porosity, and the control of the pore size can also be achieved by adjusting the wire diameter. In addition, it is measured that the average pore size of the sample with the porosity of 45% prepared by the alloy wire with the diameter of 0.1 mm can be reduced to 51 μm.

The embodiments of the present invention are not limited to the embodiments described above, and other changes, modifications, substitutions, combinations, and simplifications which do not depart from the spirit and scope of the present invention are intended to be construed as being equivalents thereof, which are included in the protection scope of the present invention.

1. An ultrahigh strain recovery shape memory alloy screen pipe material, wherein the ultrahigh strain recovery shape memory alloy screen pipe material is obtained by cold pressing molding of a preform, the preform is prepared by winding a NiTi shape memory alloy wire into a spiral coil and then winding, the spiral coil of the NiTi shape memory alloy wire in the preform is structurally embedded or interlocked with each other, and the alloy screen pipe material has a recovery strain of 43-83% at a temperature of 100-350° C.

2. The ultrahigh strain recovery shape memory alloy screen pipe material according to claim 1, wherein a titanium content of the NiTi shape memory alloy wire is 49.6-56% in terms of an atomic ratio.

3. The ultrahigh strain recovery shape memory alloy screen pipe material according to claim 1, wherein the NiTi shape memory alloy wire is a single martensite phase or a composite phase of Ti₂Ni and B19′ martensite at room temperature.

4. The ultrahigh strain recovery shape memory alloy screen pipe material according to claim 1, wherein a diameter of the NiTi shape memory alloy wire is 0.05-0.5 mm.

5. The ultrahigh strain recovery shape memory alloy screen pipe material according to claim 1, wherein a porosity of the alloy screen pipe material is 45-81%, an average pore size is 51-500 μm, a recoverable strain reaches at least 43%, and a recovery stress is in a MPa level.

6. A preparation method of the ultrahigh strain recovery shape memory alloy screen pipe material according to claim 1, wherein the preparation method comprises the following steps:
1) winding to form a spiral coil: winding a cleaned NiTi shape memory alloy wire around a mandrel to form the spiral coil;
2) preparing a preform: winding the obtained spiral coil to prepare the preform, wherein the spiral coil of the NiTi shape memory alloy wire in the preform is structurally embedded or interlocked with each other; and
3) performing cold pressing molding: placing the preform into a mold for cold pressing molding to obtain the ultrahigh strain recovery shape memory alloy screen pipe material.

7. The preparation method of the ultrahigh strain recovery shape memory alloy screen pipe material according to claim 6, wherein before winding the obtained spiral coil to prepare the preform, the preparation method further comprises stretching the spiral coil so that a ratio of a pitch of the stretched spiral coil to a mean diameter of the spiral coil is (0.95:1) to (1.05:1); a ratio of a height of the preform to a height of a sample obtained after the cold pressing molding is necessarily controlled between (2:1) to (7:1); and the cleaning is to remove oil stains on a surface of the NiTi shape memory alloy wire.

8. The preparation method of the ultrahigh strain recovery shape memory alloy screen pipe material according to claim 7, wherein a solution adopted for the cleaning is a 95% alcohol solution, and a method for cleaning is ultrasonic cleaning, and cleaning time is 10-30 min.

9. The preparation method of the ultrahigh strain recovery shape memory alloy screen pipe material according to claim 6, wherein a diameter of the mandrel is 0.5-4 mm, and a material of the mandrel is stainless steel; and a ratio of the diameter of the mandrel to a diameter of the alloy wire is controlled to be 5−(15:1); and
a loading rate of the cold pressing molding is 1-5 mm/min, a pressure for cold pressing is 2-80 kN, displacement loading control is adopted, and pressure holding time is 10-60 min.

10. An application of the ultrahigh strain recovery shape memory alloy screen pipe material according to claim 1 in sand control in oil and gas drilling and well completion.

11. An application of the ultrahigh strain recovery shape memory alloy screen pipe material according to claim 2 in sand control in oil and gas drilling and well completion.

12. An application of the ultrahigh strain recovery shape memory alloy screen pipe material according to claim 3 in sand control in oil and gas drilling and well completion.

13. An application of the ultrahigh strain recovery shape memory alloy screen pipe material according to claim 4 in sand control in oil and gas drilling and well completion.

14. An application of the ultrahigh strain recovery shape memory alloy screen pipe material according to claim 5 in sand control in oil and gas drilling and well completion.
